(19) United States
(12) Patent Application Publication
(10) Pub. No.: US 2020/0167289 A1
(43) Pub. Date: May 28, 2020

(54) DATA CACHE METHOD APPLIED TO DISPLAY DRIVER OF MOBILE DEVICE

(71) Applicant: Raydium Semiconductor Corporation, Hsinchu (TW)

(72) Inventors: SHENG-YI LIN, Hsinchu City (TW); WEI-KAI SU, Changhua County (TW)

(21) Appl. No.: 16/691,783

(22) Filed: Nov. 22, 2019

(30) Foreign Application Priority Data
Nov. 27, 2018 (TW) 107142317

(51) Int. Cl. G06F 12/0875

(52) U.S. Cl. CPC G06F 12/0875; G06F 2212/452; G06F 2212/1028

(57) ABSTRACT

A data cache method applied to a display driver of a mobile device is disclosed. The display driver includes a data input terminal, a data output terminal, an operation circuit, first buffers and second buffers. The data cache method includes following steps of: (a) storing preset operation input data and preset operation results in the first buffers and the second buffers respectively; (b) when the data input terminal receives input data, comparing whether the input data is the same with the preset operation input data stored in the first buffers; and (c) if yes, obtaining corresponding preset operation result from the preset operation results stored in the second buffers according to the preset operation input data the same with the input data and then the data output terminal outputs the corresponding preset operation result.

### BACKGROUND OF THE INVENTION

### 1. Field of the Invention

The invention relates to a display driver; in particular, to a data cache method applied to a display driver of a mobile device.

### 2. Description of the Prior Art

In general, when a display driver of a conventional mobile device receives the input image data, the operation circuit of the display driver needs to calculate the input image data and output it to the display panel for displaying.

Therefore, even if the input image data is a black-and-white figure or a drawing with less gray-scale changes, the display driver of the conventional mobile device still requires a lot of power to perform calculations, thereby it is hard to effectively reduce the power consumption of the conventional mobile device.

### SUMMARY OF THE INVENTION

Therefore, the invention provides a data cache method applied to a display driver of a mobile device to solve the above-mentioned problems occurred in the prior arts.

An embodiment of the invention is a data cache method. In this embodiment, the data cache method is applied to a display driver of a mobile device to reduce power consumption of the display driver. The display driver includes a data input terminal, a data output terminal, an operation circuit, a plurality of first buffers and a plurality of second buffers. The data cache method includes steps of: (a) storing a plurality of preset operation input data and a plurality of preset operation results in the plurality of first buffers and the plurality of second buffers respectively; (b) when the data input terminal receives an input data, comparing whether the input data is the same with the plurality of preset operation input data stored in the plurality of first buffers; and (c) if a comparison result of the step (b) is yes, obtaining a corresponding preset operation result from the plurality of preset operation results stored in the plurality of second buffers according to a preset operation input data the same with the input data and then the data output terminal outputting the corresponding preset operation result.

In an embodiment, the plurality of preset operation input data has a one-to-one correspondence with the plurality of preset operation results.

In an embodiment, the data cache method further includes a step of: (d) if the comparison result of the step (b) is no, the operation circuit calculating a corresponding operation result based on the input data, and storing the input data and the operation result in a longest unupdated first buffer of the plurality of first buffers and a longest unupdated second buffer of the plurality of second buffers respectively.

In an embodiment, the operation circuit is coupled between the data input terminal and the data output terminal, the plurality of first buffers is coupled to the data input terminal and the plurality of second buffers is coupled to the data output terminal.

In an embodiment, the plurality of first buffers and the plurality of second buffers are first in first out (FIFO) buffers.

In an embodiment, in the step (c), the input data is not transmitted to the operation circuit for calculation to reduce the power consumption of the operation circuit.

In an embodiment, the step (c) includes steps of: (c1) when the preset operation input data the same with the input data is stored in a first buffer of the plurality of first buffers, determining a cache number according to the first buffer; and (c2) selecting a corresponding second buffer of the plurality of second buffers according to the cache number and outputting the preset operation result stored in the second buffer through the data output terminal.

In an embodiment, the preset operation input data stored in the first buffer has a one-to-one correspondence with the preset operation result stored in the second buffer.

In an embodiment, the probability that the comparison result of the step (b) is yes is related to the number of the plurality of preset operation input data stored in the plurality of first buffers and the number of the plurality of preset operation results stored in the plurality of second buffers respectively.

In an embodiment, the number of the plurality of preset operation input data and the number of the plurality of preset operation results are preferably 8 to 16.

Compared to the prior art, the data cache method applied to the display driver of the mobile device in the invention compares whether the input data is the same with the preset operation input data stored in the cache buffer. If the input data is the same with the preset operation input data, the corresponding preset operation result the data can be directly outputted, so that the operation circuit can save a plurality of operations to achieve power saving effect. In particular, when the input data is a black-and-white figure or a drawing with less gray-scale changes, since the probability that the input data is the same with the preset operation input data becomes higher, more operations will be saved and more power can be effectively saved.

The advantage and spirit of the invention may be understood by the following detailed descriptions together with the appended drawings.

### BRIEF DESCRIPTION OF THE APPENDED DRAWINGS

FIG. 1 illustrates a flowchart of the data cache method in an embodiment of the invention.

FIG. 2 illustrates a flowchart of the step S18 in FIG. 1 including steps S180˜S183.

FIG. 3 illustrates a schematic diagram of the display driver applying the data cache method in an embodiment of the invention.

FIG. 4 illustrates a schematic diagram showing that the operation circuit stores the input data in the longest unupdated first buffer of the plurality of first buffers.

### DETAILED DESCRIPTION OF THE INVENTION

An embodiment of the invention is a data cache method. In this embodiment, the data cache method is applied to a display driver of a mobile device to reduce power consumption of the display driver. The display driver includes a data input terminal, a data output terminal, an operation circuit, a plurality of first buffers and a plurality of second buffers. The operation circuit is coupled between the data input terminal and the data output terminal. The plurality of first buffers is coupled to the data input terminal and the plurality of second buffers is coupled to the data output terminal.

In practical applications, the plurality of first buffers and the plurality of second buffers are cache buffers, such as first in first out (FIFO) buffers, but not limited to this.

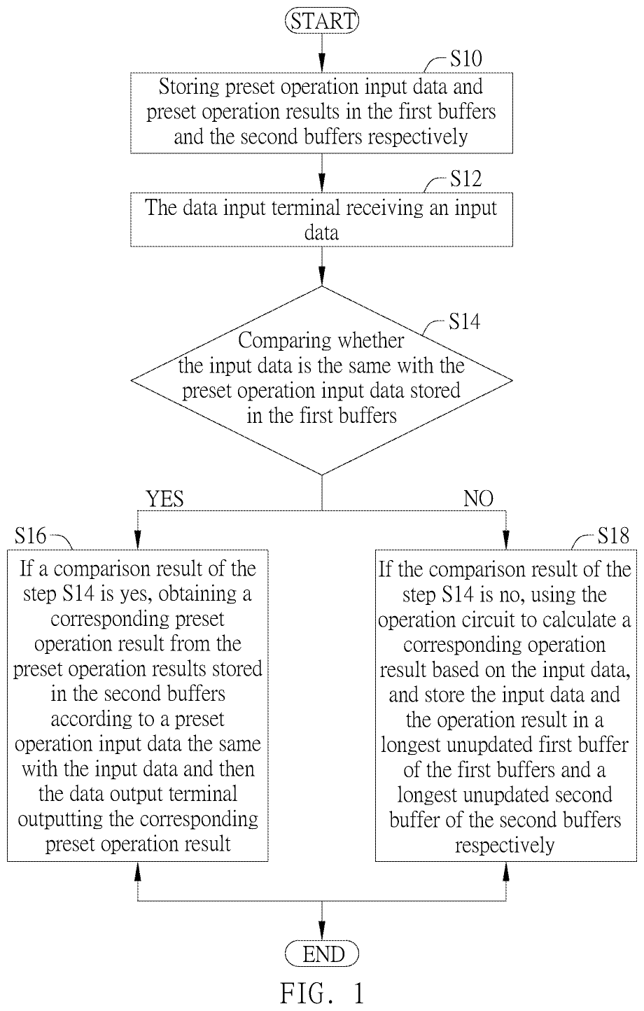

Please refer to FIG. 1. FIG. 1 illustrates a flowchart of the data cache method in this embodiment.

As shown in FIG. 1, the data cache method can include steps of:

Step S10: storing a plurality of preset operation input data and a plurality of preset operation results in the plurality of first buffers and the plurality of second buffers respectively, wherein the plurality of preset operation input data has a one-to-one correspondence with the plurality of preset operation results, and the number of the plurality of preset operation input data and the number of the plurality of preset operation results are preferably 8 to 16, but not limited to this;

Step S12: the data input terminal receiving an input data;

Step S14: comparing whether the input data is the same with the plurality of preset operation input data stored in the plurality of first buffers;

Step S16: if a comparison result of the step S14 is yes, obtaining a corresponding preset operation result from the plurality of preset operation results stored in the plurality of second buffers according to a preset operation input data the same with the input data and then the data output terminal outputting the corresponding preset operation result; and

Step S18: if the comparison result of the step S14 is no, using the operation circuit to calculate a corresponding operation result based on the input data, and store the input data and the operation result in a longest unupdated first buffer of the plurality of first buffers and a longest unupdated second buffer of the plurality of second buffers respectively.

It should be noted that, if the comparison result of the step S14 is yes, that is to say, the input data is the same with the preset operation input data stored in the plurality of first buffers, in order to reduce the unnecessary power consumption of the operation circuit, the input data will be not transmitted to the operation circuit for calculation in step S16.

In practical applications, there is a one-to-one correspondence between the preset operation input data stored in the first buffer and the preset operation result stored in the second buffer. In addition, the probability that the comparison result of the step S14 is yes is related to the number of the preset operation input data stored in the plurality of first buffers and the number of the preset operation results stored in the plurality of second buffers.

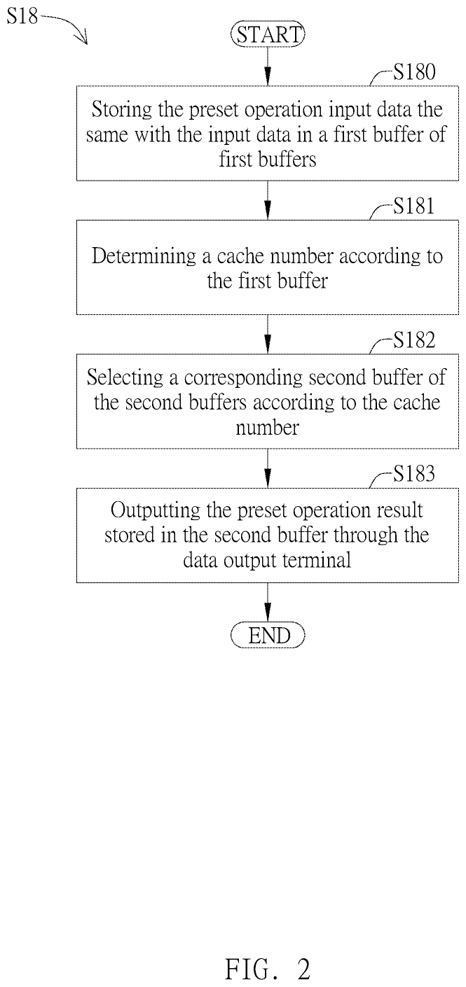

As shown in FIG. 2, the step S18 can include the following steps S180˜S183:

Step S180: storing the preset operation input data the same with the input data in a first buffer of the plurality of first buffers;

Step S181: determining a cache number according to the first buffer;

Step S182: selecting a corresponding second buffer of the plurality of second buffers according to the cache number; and

Step S183: outputting the preset operation result stored in the second buffer through the data output terminal.

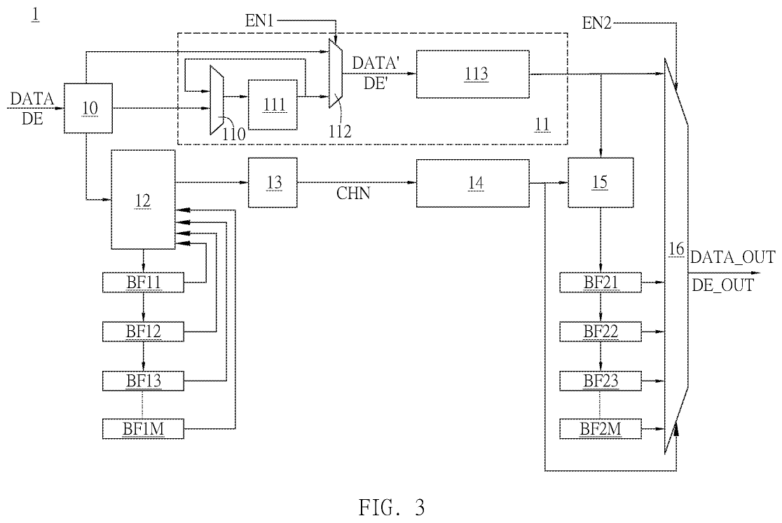

Then, please refer to FIG. 3. FIG. 3 illustrates a schematic diagram of the display driver applying the data cache method in an embodiment of the invention.

As shown in FIG. 3, the display driver 1 can include a data input terminal 10, an operation circuit 11, a comparing unit 12, a determination unit 13, a receiving unit 14, a control unit 15, a data output terminal 16, M first buffers BF11˜BF1M and M second buffers BF21˜BF2M. M is a positive integer, and the operation circuit 11 can include a multiplexer 110, a flip-flop 111, a multiplexer 112 and a data processing unit 113, but not limited to this.

The operation circuit 11 is coupled between the data input terminal 10 and the data output terminal 16; the M first buffers BF11˜BF1M are coupled to the data input terminal 10 and the M second buffers BF21˜BF2M are coupled to the data output terminal 10; the comparing unit 12 is coupled to the data input terminal 10, the operation circuit 11, the determination unit 13, and the M first buffers BF11˜BF1M; the determination unit 13 is coupled between the comparing unit 12 and the receiving unit 14; the receiving unit 14 is coupled between the determination unit 13 and the control unit 15, and the receiving unit 14 is also coupled to the data output terminal 16; the control unit 15 is coupled to the operation circuit 11, the receiving unit 14 and the M second buffers BF21˜BF2M; the data output terminal 16 is coupled to the arithmetic circuit 11, the receiving unit 14 and the M second buffers BF21˜BF2M.

At first, the M first buffers BF11˜BF1M and the M second buffers BF21˜BF2M store M preset operation input data and M preset operation results respectively (i.e., the step S10). There is a one-to-one correspondence relationship between the M preset operation input data and the M preset operation results, and the number of the M preset operation input data and the number of the M preset operation results are preferably 8 to 16, but not limited to this.

When the data input terminal 10 receives the input data DATA (i.e., the step S12), the comparing unit 12 will compare whether the input data DATA and the M preset operation input data stored in the M first buffers BF11˜BF1M are the same (i.e., the step S14).

It should be noted that the data input terminal 10 also receives the digital input signal DE at the same time. When the digital input signal DE is 1, the comparing unit 12 will compare whether the input data DATA and the M preset operation input data stored in the M first buffer BF11˜BF1M are the same. When the digital input signal DE is 0, it means that the input data DATA belongs to the non-effective data interval, so that the operation is not performed via the operation circuit 11 to save power.

If the comparison result of the comparing unit 12 is yes, the comparing unit 12 will inform the determination unit 13 which one of the M first buffers BF11˜BF1M (For example, the first buffer BF11) stores the first operational input data of the M preset operational input data the same with the input data DATA, and then the decision unit 13 will determine the cache number CHN based on the first buffer (for example, the first buffer BF11) and transmit it to the receiving unit 14. At this time, the digital input signal DE will be switched to 0, so that the operation circuit 11 will stop the operation on the input data DATA to save power.

Next, the receiving unit 14 will transmit the cache number CHN to the control unit 15 and the data output terminal 16 respectively. Since the M preset operation input data stored in the M first buffers BF11˜BF1M and the M preset operation results stored in the M second buffers BF21˜BF2M have a one-to-one corresponding relationship, when the control unit 15 receives the cache number CHN, the control unit 15 can select a corresponding preset operation result (for example, the preset operation result stored in the second buffer BF21) from the M preset operation results stored in the M second buffers BF21˜BF2M according to the cache number CHN and transmit it to the data output terminal 16 and outputted by the data output terminal 16 (i.e., the step S16). At this time, the digital output signal DE OUT will be switched to 1.

If the comparison result of the comparing unit 12 is no, the digital input signal DE is 1, the comparison unit 12 will store the input data DATA into the longest unupdated first buffer (for example, the first buffer BF11) of the M first buffers BF11˜BF1M, and the comparing unit 12 will transmit the input data DATA to the operation circuit 11, and the operation circuit 11 will calculate the corresponding operation result according to the input data DATA and then transmit the operation result to the control unit 15. The control unit 15 will store the corresponding operation result in the longest unupdated second buffer (for example, the second buffer BF21) of the M second buffers BF21˜BF2M. At this time, the operation circuit 11 stops performing operation on the input data DATA to save power.

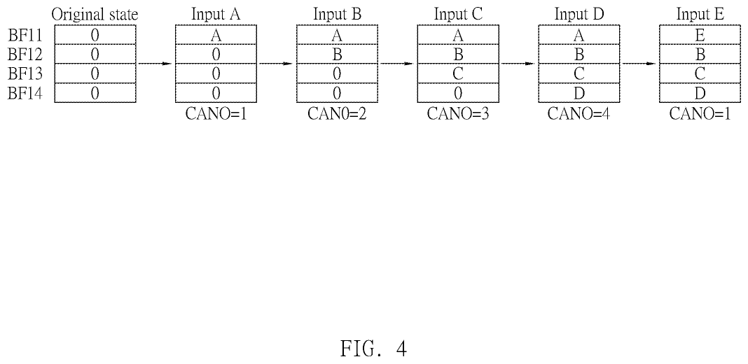

For example, as shown in FIG. 4, it is assumed that in the original state, the preset operation input data stored in the first buffers BF11˜BF14 are all 0, and the order of the first buffers BF11˜BF14 from long unupdated time to short unupdated time will be: BF11, BF12, BF13 and BF14.

When the input data DATA is A, since A and the preset operation input data 0 stored in the first buffers BF11˜BF14 are different, that is to say, the comparison result of the comparing unit 12 is no, the comparing unit 12 will store A in the longest unupdated first buffer BF11 of the first buffers BF11˜BF14. At this time, the output cache number CANO is 1.

Then, when the input data DATA is B, since B is different from the preset operation input data A and 0 stored in the first buffers BF11˜BF14, that is to say, the comparison result of the comparing unit 12 is no, and the first buffer BF11 has been updated, the comparing unit 12 will store B in the longest unupdated first buffer BF12 of the first buffers BF11˜BF14. At this time, the output cache number CANO is 2.

Next, when the input data DATA is C, since C is different from the preset operation input data A, B and 0 stored in the first buffers BF11˜BF14, that is to say, the comparison result of the comparing unit 12 is no, and the first buffers BF11˜BF12 have been updated, the comparing unit 12 will store C in the longest unupdated first buffer BF13 of the first buffers BF11˜BF14. At this time, the output cache number CANO is 3.

Similarly, when the input data DATA is D, since D is different from the preset operational input data A, B, C and 0 stored in the first buffers BF11˜BF14, that is to say, the comparison unit of the comparing unit 12 is no, and the first buffers BF11˜BF13 have been updated, the comparing unit 12 will store D in the longest unupdated first buffer BF14 of the first buffers BF11˜BF14. At this time, the output cache number CANO is 4.

Then, when the input data DATA is E, since E is different from the preset operation input data A, B, C and D stored in the first buffers BF11˜BF14, that is to say, the comparison result of the comparing unit 12 is no, and the first buffers BF11˜BF14 have been updated, so that the longest unupdated one of the first buffers BF11˜BF14 will be the first buffer BF11, and the comparing unit 12 will store E in the first buffer BF11. At this time, the output cache number CANO is 1. The rest can be deduced by analogy, and will not be described here.

Compared to the prior art, the data cache method applied to the display driver of the mobile device in the invention compares whether the input data is the same with the preset operation input data stored in the cache buffer. If the input data is the same with the preset operation input data, the corresponding preset operation result the data can be directly outputted, so that the operation circuit can save a plurality of operations to achieve power saving effect. In particular, when the input data is a black-and-white figure or a drawing with less gray-scale changes, since the probability that the input data is the same with the preset operation input data becomes higher, more operations will be saved and more power can be effectively saved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data cache method applied to a display driver of a mobile device to reduce power consumption of the display driver, the display driver comprising a data input terminal, a data output terminal, an operation circuit, a plurality of first buffers and a plurality of second buffers, the data cache method comprising steps of:
(a) storing a plurality of preset operation input data and a plurality of preset operation results in the plurality of first buffers and the plurality of second buffers respectively;
(b) when the data input terminal receives an input data, comparing whether the input data is the same with the plurality of preset operation input data stored in the plurality of first buffers; and
(c) if a comparison result of the step (b) is yes, obtaining a corresponding preset operation result from the plurality of preset operation results stored in the plurality of second buffers according to a preset operation input data the same with the input data and then the data output terminal outputting the corresponding preset operation result.

2. The data cache method of claim 1, wherein the plurality of preset operation input data has a one-to-one correspondence with the plurality of preset operation results.

3. The data cache method of claim 1, further comprising a step of:
(d) if the comparison result of the step (b) is no, the operation circuit calculating a corresponding operation result based on the input data, and storing the input data and the operation result in a longest unupdated first buffer of the plurality of first buffers and a longest unupdated second buffer of the plurality of second buffers respectively.

4. The data cache method of claim 1, wherein the operation circuit is coupled between the data input terminal and the data output terminal, the plurality of first buffers is coupled to the data input terminal and the plurality of second buffers is coupled to the data output terminal.

5. The data cache method of claim 1, wherein the plurality of first buffers and the plurality of second buffers are first in first out (FIFO) buffers.

6. The data cache method of claim 1, wherein in the step (c), the input data is not transmitted to the operation circuit for calculation to reduce the power consumption of the operation circuit.

7. The data cache method of claim 1, wherein the step (c) comprises steps of:
(c1) when the preset operation input data the same with the input data is stored in a first buffer of the plurality of first buffers, determining a cache number according to the first buffer; and
(c2) selecting a corresponding second buffer of the plurality of second buffers according to the cache number and outputting the preset operation result stored in the second buffer through the data output terminal.

8. The data cache method of claim 7, wherein the preset operation input data stored in the first buffer has a one-to-one correspondence with the preset operation result stored in the second buffer.

9. The data cache method of claim 1, wherein the probability that the comparison result of the step (b) is yes is related to the number of the plurality of preset operation input data stored in the plurality of first buffers and the number of the plurality of preset operation results stored in the plurality of second buffers respectively.

10. The data cache method of claim 9, wherein the number of the plurality of preset operation input data and the number of the plurality of preset operation results are preferably 8 to 16.
